(19) United States
(12) Patent Application Publication
(10) Pub. No.: US 2019/0241138 A1
(43) Pub. Date: Aug. 8, 2019

(54) ILLUMINATED VEHICLE PANEL

(71) Applicant: Ford Global Technologies, LLC, Dearborn, MI (US)

(72) Inventors: Stuart C. Salter, White Lake, MI (US); Paul Kenneth Dellock, Northville, MI (US); Richard Gall, Ann Arbor, MI (US); Aaron Bradley Johnson, Allen Park, MI (US)

(73) Assignee: Ford Global Technologies, LLC

(21) Appl. No.: 15/891,548

(22) Filed: Feb. 8, 2018

(51) Int. Cl. B60R 19/52; B60Q 3/62; B60Q 3/30

(52) U.S. Cl. CPC B60R 19/52; B60Q 3/78; B60Q 3/30; B60Q 3/62

(57) ABSTRACT

A vehicle radiator cover is provided herein. The vehicle radiator cover includes an elongated panel disposed within an engine compartment, the elongated panel having a diffraction grating operably coupled therewith. A first light source is disposed proximate the panel. The diffraction grating diffracts light from the first light source as a first visible iridescent pattern.

### FIELD OF THE INVENTION

The present disclosure generally relates to vehicle panels, and more particularly, to illuminated vehicle panels.

### BACKGROUND OF THE INVENTION

Vehicle panels are employed in vehicles for various functions, such as to protect and/or support various components of the vehicle. For some vehicles, it may be desirable to have a vehicle panel that that can provide the desired function while having a unique aesthetic appearance.

### SUMMARY OF THE INVENTION

According to one aspect of the present disclosure, a vehicle radiator cover is provided herein. The vehicle radiator cover includes an elongated panel disposed within an engine compartment, the elongated panel having a diffraction grating operably coupled therewith. A first light source is disposed proximate the panel. The diffraction grating diffracts light from the first light source as a first visible iridescent pattern.

According to another aspect of the present disclosure, a vehicle radiator cover is provided herein. The vehicle radiator cover includes an elongated panel disposed within an engine compartment. The elongated panel has a diffraction grating operably coupled therewith. A light source is disposed proximate the panel. The diffraction grating diffracts light from the light source as a first visible iridescent pattern. A filler is disposed with the elongated panel and is configured to provide a sparkling appearance to the elongated panel.

According to yet another aspect of the present disclosure, a vehicle component is provided herein. The vehicle component includes an elongated panel having a diffraction grating operably coupled therewith. A light source disposed proximate the panel. The diffraction grating diffracts light from the light source as a first visible iridescent pattern. A filler is disposed with the elongated panel and configured to provide a sparkling appearance to the elongated panel.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a perspective view of a front portion of a vehicle having an elongated panel disposed within an engine compartment, according to some examples;

FIG. 2 is a perspective view of the front portion of the vehicle having the elongated panel removed from the engine compartment, according to some examples;

FIG. 3 is a top perspective view of the elongated panel having light sources disposed therearound, according to some examples;

FIG. 4 is a top-down, perspective plan view of the elongated panel with edge-mounted light sources obscured and coupled to a controller, according to some examples;

FIG. 4A is a cross-sectional view of the elongated panel taken along the line IVA-IVA of FIG. 4; and

FIG. 4B is an enlarged, cross-sectional view of area IVB of FIG. 4A illustrating an exemplary diffraction grating incorporated into an interior surface of the elongated panel depicted in FIG. 4.

### DETAILED DESCRIPTION OF THE PREFERRED EXAMPLES

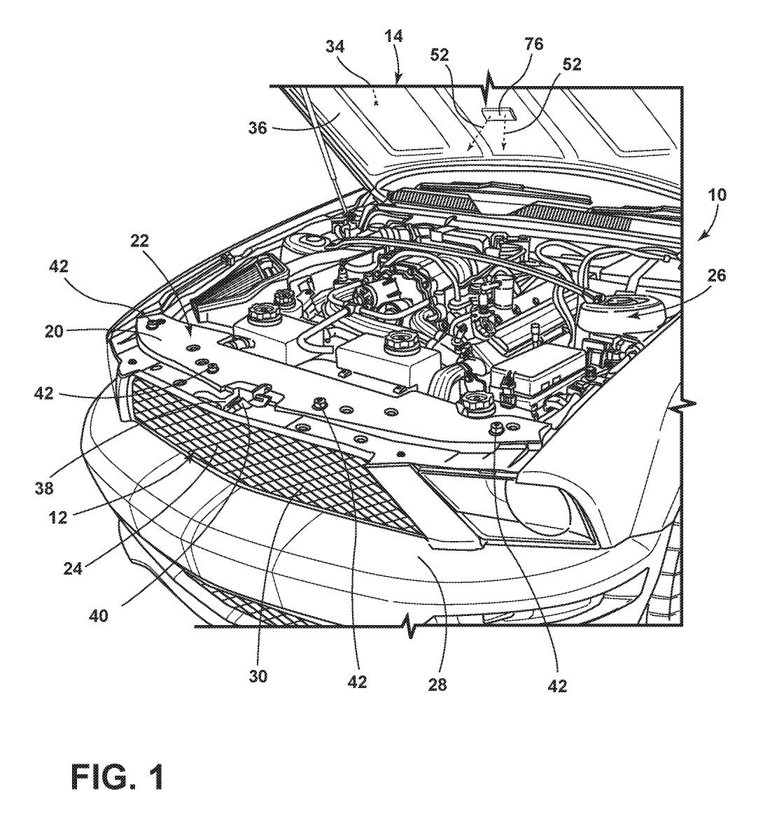

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary examples of the inventive concepts defined in the appended claims. Hence, specific dimensions and other physical characteristics relating to the examples disclosed herein are not to be considered as limiting, unless the claims expressly state otherwise.

As required, detailed examples of the present invention are disclosed herein. However, it is to be understood that the disclosed examples are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The following disclosure describes a vehicle radiator cover that includes an elongated panel disposed within an engine compartment. The elongated panel may have a diffraction grating operably coupled therewith. A first light source is disposed proximate the panel. The diffraction grating diffracts light from the light source as a first visible iridescent pattern. A filler may be disposed within the elongated panel and is configured to provide a sparkling appearance to the elongated panel.

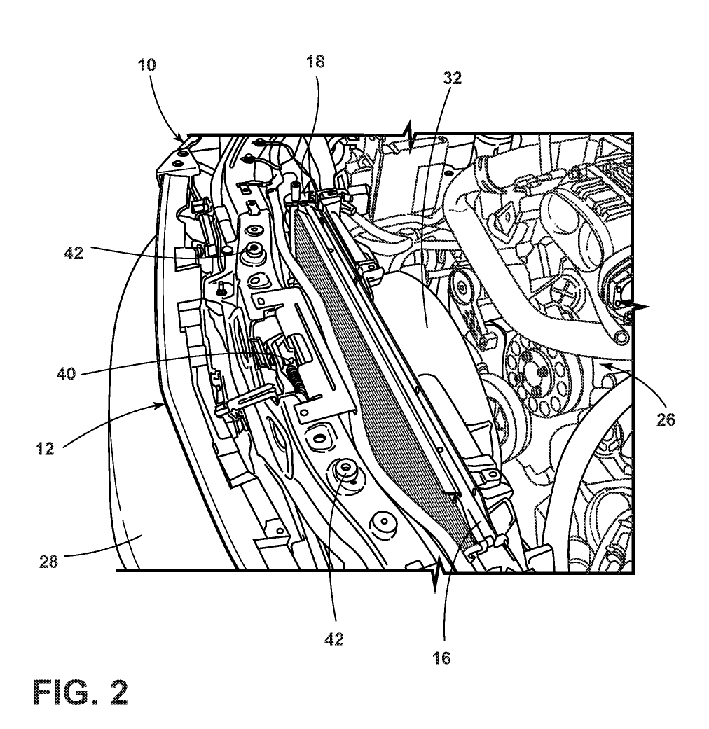

Referring to FIGS. 1 and 2, a vehicle 10, in some examples, includes a grille 12, an engine compartment hood 14, a radiator 16, a radiator support 18, an elongated panel that may be configured as a radiator cover 22, and air intake ports 24. In other examples, the elongated panel may form any other vehicle component within an engine compartment 26 or any other vehicle component on or within the vehicle 10. The grille 12 is disposed between a front bumper 28 and the engine compartment hood 14. The grille 12 is provided with grille fins 30 that define the intake ports 24 between the respective grille fins 30. An intake port 24 may also be provided between the grille 12 and the front bumper 28.

The radiator support 18 is disposed on the vehicle rear side of the grille 12 and is formed to at least partially surround the radiator 16. The radiator support 18 may be configured to maintain the radiator 16 in a desired orientation in relation to the vehicle 10 and/or the grille 12. According to some examples, the radiator 16 is aligned in a predefined manner with the grille 12 to produce airflow along the radiator 16 when the vehicle 10 is in motion. The radiator support 18 may also provide at least some support for a fan 32 that may be fluidly coupled with the radiator 16.

The engine compartment hood 14 is provided at the vehicle upper side of the grille 12 and the radiator support 18. The engine compartment hood 14 is movable between a closed position and an open position. In the open position, the engine compartment 26 and the radiator cover 22 are each accessible. The engine compartment hood 14 includes a hood outer panel 34 that may form a styling face of the engine compartment hood 14, and a hood inner panel 36 that may reinforce the hood outer panel 34.

The radiator cover 22 is disposed at the vehicle upper side of the grille 12 and the radiator support 18, and at the vehicle lower side of the hood inner panel 36. The radiator cover 22 is separated from the hood inner panel 36 and may be formed as an elongated panel 20 extending vehicle side-to-side across the engine compartment 26. The radiator cover 22 may be formed from a polymeric material, an elastomeric material, a metallic material, combinations thereof, and/or any other material known in the art to form an elongated panel 20. The radiator cover 22 is removably fixed to the vehicle 10 through one or more fasteners. A striker opening 38, through which a striker is disposed for locking the engine compartment hood 14 in the closed position. One or more bumpers 42 may extend through the radiator cover 22 and/or attach to the elongated panel 20.

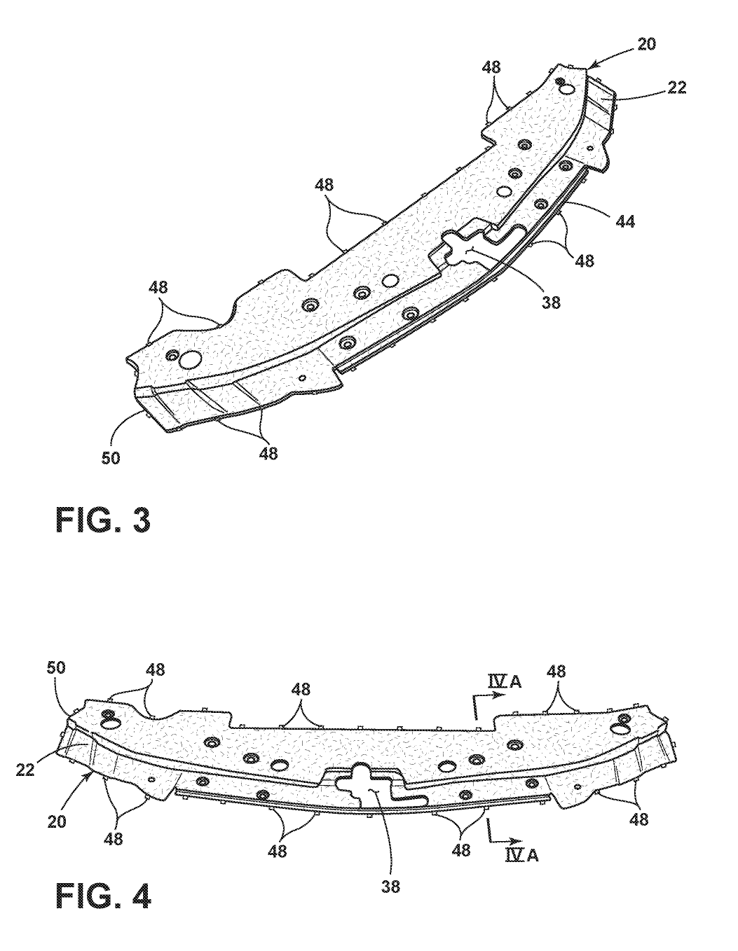

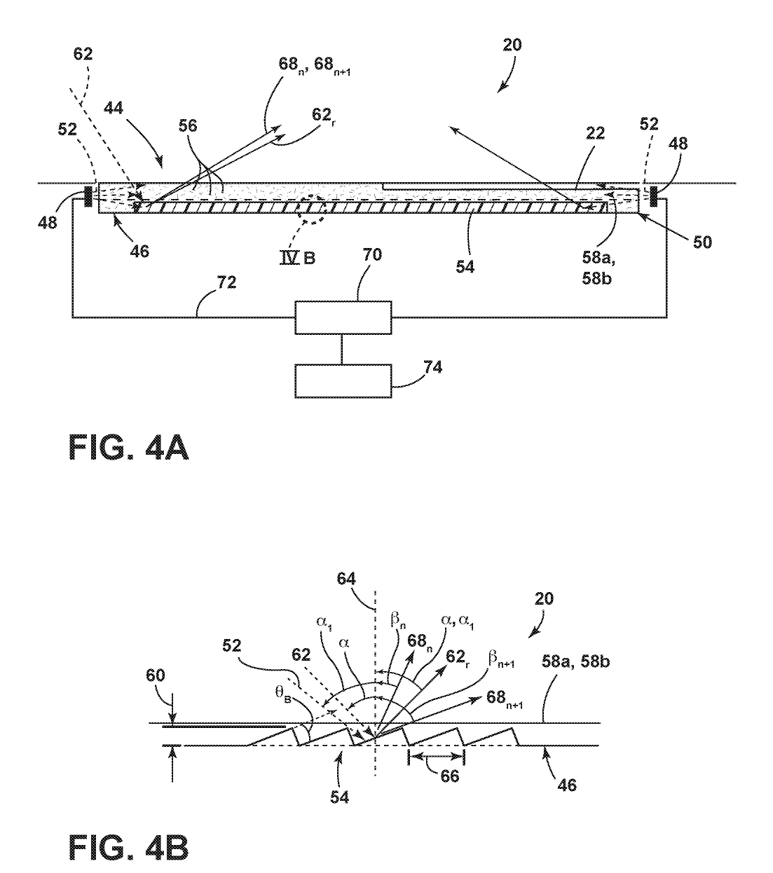

Referring to FIGS. 3 and 4, the elongated panel 20 is disposed within the engine compartment 26 in some examples. However, in other examples, any elongated panel 20 within and/or on the vehicle 10 may be manufactured in accordance with the teachings provided herein without departing from the scope of the present disclosure. For example, the panel may be a structural component of the vehicle 10, a decorative panel on the vehicle 10, an elongated panel 20, trim assembly and other exterior surface assemblies (collectively, “elongated panel”) for vehicles (e.g., automobiles, watercraft, motorcycles, etc.) and other structures (e.g., architectural elements).

The elongated panel 20 includes one or more exterior surfaces 44 and one or more interior surfaces 46 (FIG. 4A). In some aspects, the elongated panel 20 is characterized by an optical transmissivity of 85% or more over the visible spectrum (e.g., 390 to 700 nm). In some examples, the elongated panel 20 is characterized by an optical transmissivity of 90% or more, and possibly, 95% or more, over the visible spectrum. Further, the elongated panel 20 can be optically clear with no substantial coloration. In other examples, the elongated panel 20 can be tinted (e.g., with one or more colors, smoke-like effects, or other gradations and intentional non-uniformities) and/or affixed with one or more filters on its exterior surfaces 44 and/or interior surfaces 46 to obtain a desired hue (e.g., blue, red, green, etc.) or other effect.

Referring again to FIGS. 3 and 4, the elongated panel 20 may be fabricated from a polymeric material. These polymeric materials include thermoplastic and thermosetting polymeric materials, e.g., silicones, acrylics, and polycarbonates. In some examples, the precursor material(s) employed to fabricate the elongated panel 20 are selected to have a high flow rate and/or a low viscosity during a molding process such as injection molding. In other examples, the precursor material(s) employed to fabricate the elongated panel 20 are selected with higher viscosity levels based on cost or other considerations when a less viscosity-dependent process is employed, such as insert molding. According to another example, ultraviolet light-resistant materials and/or treatments may be employed in the elongated panel 20 to enhance its resistance to ambient light-related degradation.

The elongated panel 20 can take on any of a variety of shapes, depending on the features of the panel, vehicle insignia, and other design considerations. For example, in some examples, one or more of the exterior and interior surfaces 44, 46 of the elongated panel 20 are planar (e.g., faceted), non-planar, curved or characterized by other shapes. As also understood by those with ordinary skill in the field, the exterior and interior surfaces 44, 46 can be characterized with portions having planar features and portions having non-planar features.

In some aspects, fillers 56 (FIG. 4A), e.g., flakes, beads, particles, and other similar filler elements can be added to the polymeric material, serving as a matrix, to form the elongated panel 20 without significant detriment to the optical properties of the elongated panel 20. These fillers 56 can provide added durability and/or additional aesthetic effects to the elongated panel 20. The flakes in the polymeric material may be randomly oriented. Once the flakes are encapsulated, they may be substantially hydrodynamically isotropic and are thereby substantially insensitive to flow direction. This may reduce or eliminate the appearance of the knitlines. As used herein, the term “knitline” is used to mean areas of directional and/or non-uniform flow direction. Additionally, the flakes encapsulated within the transparent, translucent, and/or colored polymer may retain their specular or mirror-like reflection characteristics. As used herein, “polymeric material” may mean any material containing any amount of polymer therein. However, it will be understood that the elongated panel 20 may be made from any other practicable material not containing a polymeric material without departing from the scope of the present disclosure.

With further reference to FIGS. 3 and 4, the fillers 56 may include any suitable material that provides the desired colored, metallic, sparkling and/or metallescent appearance in a resinous composition. Some non-limiting examples of such materials comprise aluminum, gold, silver, copper, nickel, titanium, stainless steel, nickel sulfide, cobalt sulfide, manganese sulfide, metal oxides, white mica, black mica, synthetic mica, mica coated with titanium dioxide, metal-coated glass flakes, colorants, including but not limited, to Perylene Red, or any other suitable high aspect ratio material that may be susceptible to forming flowlines when used by itself in an unencapsulated form in a resinous composition. In some examples, a mixture of a high aspect ratio colorant and a high aspect ratio additive to provide metallic, sparkling and/or metallescent appearance may be employed.

The average amount (i.e., volume) of filler encapsulated within the polymeric material may be based on a desired colored, metallic, sparkling, and/or metallescent appearance for a particular concentration of fillers 56 in a resinous composition, wherein the average amount of filler may be determined by dividing the total volume of the filler used by the total volume of the polymeric material. The average amount of filler encapsulated within the polymeric material may be less than about 25% volume, between about 0.05 and about 25% volume, between about 0.25 and about 20% volume, between about 0.5 and about 15% volume, between about 5 and about 10% volume, between about 10 to about 15% volume, between about 0.05 to about 5% volume, or between about 0.5 to about 4% volume, in various examples respectively, based on the volume of the polymeric material.

Referring again to FIG. 4, the elongated panel 20 is shown as including one or more light sources 48. In some examples, the light sources 48 are located such that they are oriented toward edges 50 of the elongated panel 20. In some implementations, the light sources 48 are placed in direct contact with the edges 50. Other implementations of the elongated panel 20 can employ light sources 48 that are in proximity to, but spaced from, the edges 50. The light sources 48 may include any form of light sources. For example, fluorescent lighting, light-emitting diodes (LEDs), organic LEDs (OLEDs), polymer LEDs (PLEDs), laser diodes, quantum dot LEDs (QD-LEDs), solid-state lighting, a hybrid of these or any other similar device, and/or any other form of lighting may be utilized in conjunction with the elongated panel 20. Further, various types of LEDs are suitable for use as the light sources 48 including, but not limited to, top-emitting LEDs, side-emitting LEDs, and others. Moreover, according to various examples, multicolored light sources 48, such as Red, Green, and Blue (RGB) LEDs that employ red, green, and blue LED packaging may be used to generate various desired colors of light outputs from a single light source 48, according to known light color mixing techniques. According to some aspects, additional optics (not shown) can be placed between the light sources 48 and the edges 50 of the elongated panel 20 to adjust, collimate, focus or otherwise shape the incident light 52 that enters the elongated panel 20 from these sources. In other aspects of the elongated panel 20, additional optics (not shown), e.g., reflectors, can be placed in proximity to the light sources 48 and the edges 50 of the elongated panel 20 to increase the portion of the incident light 52 (FIG. 4A) that enters the elongated panel 20 from the light sources 48.

Referring to FIG. 4A, the interior surfaces 46 of the elongated panel 20 may include one or more diffraction gratings 54. In some examples, the elongated panel 20 can consist of a single component. For example, the elongated panel 20 can be formed as a single piece with integral diffraction grating(s) 54 from a single mold. In such configurations, the diffraction grating(s) 54 may be located within one or more diffraction regions 58a in contact with, or in proximity to, the interior surface 46 of the elongated panel 20. In other examples, the elongated panel 20 can be formed from multiple parts and the parts may be joined (e.g., as with an optical adhesive, through an insert-molding process, etc.) with minimal detriment to the overall optical properties of the elongated panel 20.

The diffraction region 58a is loosely defined as a layer within the elongated panel 20 without appreciable boundaries that contain one or more diffraction gratings 54. In other examples, the diffraction film 58b may be in the form of a layer, foil, film, or comparable structure that is joined or otherwise fabricated to be integral with the elongated panel 20 and contains one or more diffraction gratings 54. In addition, the diffraction regions and films 58a, 58b may be from about 0.1 mm to about 1 cm in thickness. Moreover, the diffraction regions and films 58a, 58b are between about 0.1 mm and 5 mm in thickness. Further, as also depicted in FIG. 4A, the diffraction regions and films 58a, 58b can comprise diffraction gratings 54 located on planar and/or non-planar portions of the interior surfaces 46.

With further reference to FIG. 4A, the light sources 48 may be located in proximity to edges 50 of the elongated panel 20 such that the elongated panel 20 itself serves to obscure the sources 48 from view (e.g., from a vantage point above the exterior surface 44 of the elongated panel 20). In some instances, the light sources 48 are oriented in relation to the elongated panel 20 such that a substantial portion (e.g., >50%) of the incident light 52 from the light sources 48 enters the elongated panel 20. In some aspects of the elongated panel 20, one or more interior portions 46 of the exterior surface 44 can be coated with an optically reflective material such that a substantial portion of the incident light 52 from the light sources 48 within the elongated panel 20 is internally reflected within the elongated panel 20 or otherwise impinges on the diffraction gratings 54. For example, the filler 56 may reflect some of the incident light 52 from the light sources 48. In some examples, the interior portions 46 can be configured with a mirror-like coating, such as a metal-containing mirror-like film. In other examples, the interior portions 46 can comprise a non-specular, reflective coating, such as a white matte paint. Moreover, in some instances, a second light source 76 (FIG. 1) is disposed above the elongated panel 20 and is optically coupled with the elongated panel 20 and/or the diffraction gratings 54.

As shown schematically in FIG. 4B, the diffraction gratings 54 of the elongated panel 20 may be formed at a microscopic level. In some examples, the diffraction gratings 54 have a thickness 60 that ranges from 250 nm to 1000 nm. The thickness 60 of the diffraction gratings 54, for example, may be maintained in the range of 250 nm to 1000 nm such that the elongated panel 20 exhibits a jewel-like appearance through light diffraction upon direct illumination from ambient light rays 62 and incident light 52 (e.g., as from the light sources 48) while also having a minimal effect on the optical clarity of the elongated panel 20 under indirect ambient lighting. In some instances, the thickness 60 of the diffraction gratings 54 ranges from about 390 nm to 700 nm. In other examples, the thickness 60 of the diffraction gratings 54 ranges from 500 nm to 750 nm. Further, in some examples, fillers 56 (e.g., flakes) are added to the diffraction gratings 54 to enhance or otherwise modify the jewel-like appearance produced by the light 52, 62 that interacts with the diffraction gratings 54.

As also shown schematically in FIG. 4B, the grooves of the diffraction gratings 54 within the elongated panel 20 can be configured in various shapes to diffract incident light 52 and produce an iridescent and jewel-like appearance. As depicted in FIG. 4B in exemplary form, the diffraction gratings 54 have a sawtooth or triangular shape. In three dimensions, these gratings 54 can appear with a stepped or sawtooth shape without angular features (i.e., in the direction normal to what is depicted in FIG. 4B), pyramidal in shape, or some combination of stepped and pyramidal shapes. Other shapes of the diffraction gratings 54 include hill-shaped features (not shown)—e.g., stepped features with one or more curved features. The diffraction gratings 54 can also include portions with a combination of triangular and hill-shaped features. More generally, the shapes of the diffraction gratings 54 can be such that an effective blazing angle θ_{B} of at least 15 degrees is present for one or more portions of each grating, tooth, or groove of the diffraction gratings 54. The blaze angle θ_{B} is the angle between step normal (i.e., the direction normal to each step or tooth of the diffraction grating 54) and the direction normal 64 to the interior surface 46 having the diffraction grating 54.

Generally, the blaze angle θ_{B} is designed to affect the efficiency of the wavelength(s) of the incident light 52 (e.g., as from the light sources 48 during night-time conditions) and/or ambient light 62 (e.g., as from sunlight during day-time conditions) impinging on the diffraction gratings 54, such that optical power is concentrated in one or more diffraction orders while minimizing residual power in other orders (e.g., the zeroth order indicative of the ambient light itself). In some aspects, situating diffraction gratings 54 on planar portions or aspects of the interior surfaces 46 is that a constant blaze angle θ_{B} and period 66 will result in consistent reflected and diffracted light produced from the diffraction gratings 54. Such consistency can be employed by a designer of the elongated panel 20 such that desired jewel-like effects (e.g., multiple, visible iridescent patterns) are observable by individuals at different locations and distances from the elongated panel 20 upon irradiation of the diffraction gratings 54 by ambient light 62 and incident light 52 from the light sources 48.

As also shown schematically in FIG. 4B, the diffraction gratings 54 of the elongated panel 20 are characterized by one or more periods 66 (also known as d in the standard nomenclature of diffraction gratings). In some aspects of the elongated panel 20, the period 66 of the diffraction grating 54 is maintained between about 50 nm and about 5 microns. In general, the maximum wavelength that a given diffraction grating 54 can diffract is equal to twice the period 66. Hence, the diffraction grating 54 with a period 66 that is maintained between about 50 nm and about 5 microns can diffract light in a range of 100 nm to about 10 microns. In some examples, the period 66 of a diffraction grating 54 is maintained from about 150 nm to about 400 nm, such that the diffraction grating 54 can efficiently diffract light in an optical range of about 300 nm to about 800 nm upon irradiation from ambient light 62 and incident light 52 from the light sources 48, roughly covering the visible spectrum.

Referring again to FIG. 4B, ambient light 62 (possibly, ambient sunlight) at an incident angle α or incident light 52 (e.g., from light sources 48) at an incident angle α₁ is directed against a sawtooth-shaped diffraction grating 54 having a thickness 60, a period 66 and a blaze angle θ_{B}. A portion of the ambient light 62 or incident light 52 (possibly, a small portion) striking the diffraction grating 54 at an incident angle α, α₁ is reflected as reflected light 62ᵣ at the same angle α, α₁ and the remaining portion of the ambient light 62 or incident light 52 is diffracted at particular wavelengths corresponding to diffracted light 68ₙ, 68ₙ₊₁, etc., at corresponding diffraction angles βₙ, βₙ₊₁, etc. The reflected light 62ᵣ is indicative of the zeroth order (i.e., n=0) and the diffracted light 68ₙ, 68ₙ₊₁, etc., are indicative of the nth order diffraction according to standard diffraction grating terminology, where n is an integer corresponding to particular wavelengths of the reflected or diffracted light. Ultimately, the reflected light 62ᵣ and diffracted light 68ₙ, 68ₙ₊₁, etc. collectively produce variously visible, iridescent patterns that exit the elongated panel 20. In some aspects, the reflected and diffracted light from irradiation of the diffraction gratings 54 by ambient light 62 can produce a first visible, iridescent pattern; and the reflected and diffracted light from irradiation of the diffraction gratings 54 by incident light 52 from the light sources 48 can produce a second visible, iridescent pattern. According to another example of the elongated panel 20, these visible, iridescent patterns can vary as the intensity, direction and power of the ambient light 62 and/or incident light 52 striking or otherwise irradiating the diffraction gratings 54 changes over time. Similarly, iridescent patterns created by the fillers 56 can also vary as the intensity, direction and power of the ambient light 62 and/or incident light 52 striking or otherwise irradiating the filler 56 changes over time.

Referring again to FIGS. 4-4B, the diffraction gratings 54, such as depicted in an enlarged, schematic format in FIG. 4B, may be located within the elongated panel 20. In particular, the diffraction gratings 54 are generally protected from damage, alteration and/or wear due to their general location on the backside of the elongated panel 20, situated on or in proximity to the interior surfaces 46. Given that ambient light 62 and incident light 52 passes through the elongated panel 20 to reach the diffraction grating 54 and that reflected light 62ᵣ and diffracted light 68ₙ, 68ₙ₊₁, etc., also passes through the elongated panel 20 to produce visible iridescent patterns, the diffraction efficiency of a diffraction grating 54 can be affected by the thickness of the elongated panel 20 due to its absorptive effects. Accordingly, the elongated panel 20 may have high optical clarity. In some aspects, for example, the optical transmissivity of the elongated panel 20 can exceed 75% in the visible spectrum. In other aspects, the optical transmissivity of the elongated panel 20 can exceed 80%, 85%, 90%, 95%, or other transmissivity levels between these values. According to other aspects, the fact that ambient light 62 and/or incident light 52 passes through the elongated panel 20 prior to reaching the diffraction gratings 54, facilitates the development of additional visual effects through tinting, shading, and other adjustments to the structure within the elongated panel 20. For example, as provided above, fillers 56, such as flakes, can be added to the elongated panel 20, in some aspects, to alter the visible iridescent patterns produced by the elongated panel 20.

Referring back to FIG. 4A, the light sources 48 and/or elongated panel 20 can be operably coupled with a controller 70 including control circuitry including LED drive circuitry for controlling activation and deactivation of the light sources 48. In some examples, the light sources 48 are coupled to the controller 70 by wiring 72. In other examples, the light sources 48 can be coupled to the controller 70 by a wireless communication protocol, such as a BLUETOOTH® protocol or other wireless protocol as understood by those with ordinary skill in the field of the disclosure. Further, the controller 70 can be coupled to a power source 74, which functions to power the controller 70. In some examples, the power source 74 can also power the light sources 48 via the wiring 72. In other examples in which the light sources 48 are coupled to the controller 70 by a wireless protocol, the light sources 48 can include their own power source or sources (not shown). The controller 70 can be configured to control each of the light sources 48, sets of the light sources 48 or other combinations of the light sources 48. For example, the controller 70 can include manual input, user-driven programming or other inputs (e.g., as manifested in software, hardware in the form of a printed circuit board (PCB), or the like) that can facilitate individual control of the light sources 48 to direct incident light 52 into the elongated panel 20 and produce various visible iridescent patterns. In some examples, the controller 70 can adjust the power levels, timing and activation of each of the light sources 48 to effect control over the incident light 52 and thereby control the visible, iridescent patterns produced by the elongated panel 20 and may modify the intensity of the light emitted by the light sources 48 by pulse-width modulation, current control, and/or any other method known in the art. In various examples, the controller 70 may be configured to adjust a color and/or intensity of light emitted from the light sources 48 by sending control signals to adjust an intensity or energy output level of the light sources 48.

The elongated panel 20 provided herein contains one or more diffraction gratings 54 that are integral with the elongated panel 20. One or more light sources 48 are oriented toward the edge(s) 50 of the elongated panel 20. Further, the diffraction gratings 54 can be part of films that are joined, bonded, molded, or otherwise incorporated into the elongated panel 20. More generally, each of the diffraction grating(s) 54 of the elongated panel 20 provides sparkle and iridescence to the element upon irradiation with ambient and light sources 48. That is, the iridescent elongated panel 20 can produce visible iridescent patterns upon irradiation with ambient light under daytime conditions. Further, the iridescent assemblies can produce other visible iridescent patterns upon irradiation with the light source 48 that is optically coupled with the elongated panel 20.

It is also evident that various microscopic features can be added or adjusted within the diffraction gratings 54 to achieve varied aesthetic effects in the iridescent elongated panel 20 of the disclosure. Gratings can also be incorporated into various regions within the elongated panel 20 to achieve other varied, aesthetic effects. These gratings 54 can also be embossed into films that are later incorporated into the elongated panel 20. Further, the elongated panel 20, trim and other iridescent assemblies can be injection molded as one part, and typically cost only marginally more than conventional trim components. In addition, the elongated panel 20, trim, and other related vehicular elements can be insert molded from two or more parts (e.g., an elongated panel 20 and a diffraction film), with or without vacuum assistance, with process costs that are only marginally higher than the process costs for conventional elongated panels 20 and trim.

Furthermore, in some aspects, fillers, e.g., flakes, beads, particles, and other similar filler elements can be added to a polymeric material, serving as a matrix, to form the elongated panel 20 without significant detriment to the optical properties of the elongated panel 20. These fillers can provide added durability and/or additional aesthetic effects to the elongated panel 20. Additionally, the flakes encapsulated within the transparent, translucent, and/or colored elongated panel 20 may retain their specular or mirror-like reflection characteristics. The fillers may include any suitable material that provides the desired colored, metallic, sparkling and/or metallescent appearance in a resinous composition. In some examples, a mixture of a high aspect ratio colorant and a high aspect ratio additive to provide metallic, sparkling and/or metallescent appearance may be employed. The elongated panel 20 described herein may provide unique aesthetic features while being manufactured at similar or lower costs to elongated panels on the current market.

According to one aspect of the present disclosure, a vehicle radiator cover is provided herein. The vehicle radiator cover includes an elongated panel disposed within an engine compartment, the elongated panel having a diffraction grating operably coupled therewith. A first light source is disposed proximate the panel. The diffraction grating diffracts light from the first light source as a first visible iridescent pattern. Examples of the vehicle radiator cover can include any one or a combination of the following features:
a filler disposed with the elongated panel and configured to provide a sparkling or metallescent appearance to the elongated panel;
the diffraction grating has a thickness from 250 nm to 1000 nm and a period from 50 nm to 5 microns;
the filler is encapsulated within a translucent elongated panel;
the filler within the elongated panel is between about 0.05 and about 25% volume;
the filler is formed from at least one of aluminum, gold, silver, copper, nickel, titanium, stainless steel, nickel sulfide, cobalt sulfide, manganese sulfide, metal oxides, white mica, black mica, synthetic mica, mica coated with titanium dioxide, or metal-coated glass flakes;
the first light source is coupled to a controller, the controller configured to selectively activate the first light source;
the elongated panel includes an interior surface, the interior surface comprising the diffraction grating;
the diffraction grating diffracts ambient light as a second visible iridescent pattern;
a second light source is disposed above the elongated panel and is optically coupled with the diffraction gratings; and/or
the diffraction grating is configured as a film that is disposed on an interior surface of the elongated panel.

Moreover, a method of manufacturing a vehicle radiator cover is provided herein. The method includes forming an elongated panel configured for positioning within an engine compartment. A diffraction grating is formed on a bottom surface of the elongated panel. A first light source is optically coupled with the elongated panel. The diffraction grating diffracts light from the first light source as a first visible iridescent pattern.

According to another aspect of the present disclosure, a vehicle radiator cover is provided herein. The vehicle radiator cover includes an elongated panel disposed within an engine compartment. The elongated panel has a diffraction grating operably coupled therewith. A light source is disposed proximate the panel. The diffraction grating diffracts light from the light source as a first visible iridescent pattern. A filler is disposed with the elongated panel and is configured to provide a sparkling appearance to the elongated panel. Examples of the vehicle radiator cover can include any one or a combination of the following features:
the filler within the elongated panel is between about 0.05 and about 25% volume;
the elongated panel has a composition selected from the group consisting of silicones, acrylics and polycarbonates;
the diffraction grating has a thickness from 250 nm to 1000 nm and a period from 50 nm to 5 microns; and/or
a film is disposed on an interior surface of the elongated panel, the film formed by embossing.

According to yet another aspect of the present disclosure, a vehicle component is provided herein. The vehicle component includes an elongated panel having a diffraction grating operably coupled therewith. A light source disposed proximate the panel. The diffraction grating diffracts light from the light source as a first visible iridescent pattern. A filler is disposed with the elongated panel and configured to provide a sparkling appearance to the elongated panel. Examples of the vehicle component can include any one or a combination of the following features:
the filler within the elongated panel is between about 0.5 and about 25% volume;
the light source is coupled to a controller, the controller configured to selectively activate the light source; and/or
the diffraction grating has a thickness from 250 nm to 1000 nm and a period from 50 nm to 5 microns.

It will be understood by one having ordinary skill in the art that construction of the described invention and other components is not limited to any specific material. Other exemplary examples of the invention disclosed herein may be formed from a wide variety of materials unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

Furthermore, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable and/or physically interacting components and/or wirelessly interactable and/or wirelessly interacting components and/or logically interacting and/or logically interactable components. Furthermore, it will be understood that a component preceding the term “of the” may be disposed at any practicable location (e.g., on, within, and/or externally disposed from the vehicle) such that the component may function in any manner described herein.

It is also important to note that the construction and arrangement of the elements of the invention as shown in the exemplary examples is illustrative only. Although only a few examples of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connectors or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary examples without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

1. A vehicle radiator cover, comprising:
an elongated panel disposed within an engine compartment, the elongated panel having a diffraction grating integrally formed therewith; and
a first light source disposed proximate the panel, wherein the diffraction grating diffracts light from the first light source as a first visible iridescent pattern.

2. The vehicle radiator cover of claim 1, further comprising:
a filler disposed with the elongated panel and configured to provide a sparkling or metallescent appearance to the elongated panel.

3. The vehicle radiator cover of claim 1, wherein the diffraction grating has a thickness from 250 nm to 1000 nm and a period from 50 nm to 5 microns.

4. The vehicle radiator cover of claim 2, wherein the filler is encapsulated within a translucent elongated panel.

5. The vehicle radiator cover of claim 2, wherein the filler within the elongated panel is between about 0.05 and about 25% volume.

6. The vehicle radiator cover of claim 2, wherein the filler is formed from at least one of aluminum, gold, silver, copper, nickel, titanium, stainless steel, nickel sulfide, cobalt sulfide, manganese sulfide, metal oxides, white mica, black mica, synthetic mica, mica coated with titanium dioxide, or metal-coated glass flakes.

7. The vehicle radiator cover of claim 1, wherein the first light source is coupled to a controller, the controller configured to selectively activate the first light source.

8. The vehicle radiator cover of claim 1, wherein the elongated panel includes an interior surface, the interior surface comprising the diffraction grating.

9. The vehicle radiator cover of claim 1, wherein the diffraction grating diffracts ambient light as a second visible iridescent pattern.

10. The vehicle radiator cover of claim 1, wherein a second light source is disposed above the elongated panel and is optically coupled with the diffraction gratings.

11. The vehicle radiator cover of claim 10, wherein the diffraction grating is configured as a film that is disposed on an interior surface of the elongated panel.

12. A vehicle radiator cover, comprising:
an elongated panel disposed within an engine compartment, the elongated panel having a diffraction grating operably coupled therewith;
a light source disposed proximate the panel, wherein the diffraction grating diffracts light from the light source as a first visible iridescent pattern;
a filler disposed with the elongated panel and configured to provide a sparkling appearance to the elongated panel; and
a controller configured to vary the intensity of the light source to provide a varying appearance of the elongated panel.

13. The vehicle radiator cover of claim 12, wherein the filler within the elongated panel is between about 0.05 and about 25% volume.

14. The vehicle radiator cover of claim 12, wherein the elongated panel has a composition selected from the group consisting of silicones, acrylics and polycarbonates.

15. The vehicle radiator cover of claim 12, wherein the diffraction grating has a thickness from 250 nm to 1000 nm and a period from 50 nm to 5 microns.

16. The vehicle radiator cover of claim 12, wherein a film is disposed on an interior surface of the elongated panel, the film formed by embossing.

17. A vehicle component, comprising:
an elongated panel having a diffraction grating operably coupled therewith;
a plurality of light sources disposed proximate the panel, wherein the diffraction grating diffracts light from the plurality of light sources as a plurality of visible iridescent patterns;
a filler disposed with the elongated panel and configured to provide a sparkling appearance to the elongated panel; and
a controller configured to individually control each of the plurality of light sources to provide a varying appearance to the elongated panel.

18. The vehicle component of claim 17, wherein the filler within the elongated panel is between about 0.5 and about 25% volume.

19. The vehicle component of claim 17, wherein the controller is configured to individually control a property of each of the plurality of light sources selected from the group consisting of power level, intensity, timing, activation and combinations thereof.

20. The vehicle component of claim 17, wherein the diffraction grating has a thickness from 250 nm to 1000 nm and a period from 50 nm to 5 microns.
